(19) United States
(12) Patent Application Publication
(10) Pub. No.: US 2014/0222225 A1
(43) Pub. Date: Aug. 7, 2014

(54) ENERGY MANAGEMENT SYSTEM AND METHOD

(71) Applicants: Gregory C. Rouse, Sarasota, FL (US); John F. Kelly, Elmhurst, IL (US)

(72) Inventors: Gregory C. Rouse, Sarasota, FL (US); John F. Kelly, Elmhurst, IL (US)

(21) Appl. No.: 13/786,284

(22) Filed: Mar. 5, 2013

Related U.S. Application Data
(60) Provisional application No. 61/761,300, filed on Feb. 6, 2013.

(51) Int. Cl. G05B 13/02

(52) U.S. Cl. CPC G05B 13/02
USPC 700/291

(57) ABSTRACT

An energy management system utilizing a home automation aggregation controller provides a retail energy supplier with means to manage electric energy supply characteristics.

### PRIORITY CLAIM

This application claims priority to U.S. Provisional Patent Application No. 61/761,300 filed Feb. 6, 2013 and which is incorporated herein in its entirety and for all purposes.

### BACKGROUND OF THE INVENTION

1. Field of the Invention

The invention relates to a process. In particular, the invention includes a method for managing the supply of electric power.

2. Discussion of the Related Art

Electric power is supplied to residential, commercial, and industrial customers. Little thought or infrastructure has been devoted to automated means for collecting data and using that data individually and corporately to manage the energy supply to meet goals set by consumers and their energy suppliers.

### SUMMARY OF THE INVENTION

The present invention provides a method of operating an electric power energy management business. In various embodiments, the present invention provides for more effective management of electric supplies.

In an embodiment, management functions coordinate and optimize customer loads and load reduction actions, with external influences such as weather, electricity market prices and system wide loads on the grid to reduce costs, peak loads, energy consumption and carbon production. For example, aggregators can take advantage of unique value propositions for utilities and customers when these factors are optimized to benefit from their interdependence.

Notably, while some benefits of the present invention depend upon markets having de-regulated electricity prices, embodiments of the invention remain useful for managing energy consumption and carbon reduction.

Embodiments of the invention provide for peak load management including peak load reduction. For example, peak load reduction benefits utilities and Independent System Operators (“ISO”) where it enables improved asset utilization, reduced congestion on transmission and distribution wires, and reduced loads when generators are constrained.

Embodiments provide consumers benefits such as cost savings through energy conservation and reduced procurement costs. Procurement cost reductions include one or more of constructing flatter load profiles enabling participation in real time electricity markets and providing consumers with a menu of ancillary services.

Aggregation service providers package and or manage electric power loads of many consumers. They offer programs such as Community Choice Aggregation programs and subscription programs that purchase power for participating consumers. In various embodiments, aggregators fully or partially control customer loads and combine customers into groups for managing the combined load profiles of these groups. Flatten load profiles, that is load profiles that have nearly the same load over the course of every hour in the day, are more desirable because, inter alia, such profiles enhance utilization of electric power infrastructure resources. Typically, aggregators can reduce electric power costs by constructing a load profile from many consumers that tends to flatten the summed load.

When purchasing power for a group of customers, aggregators may choose to purchase all or some of the power in real time electricity markets where prices change as often as every five minutes, or in markets where the prices change hourly, for example, but are a determined the day before (“day-ahead markets”). In various embodiments, kilowatt hours purchased in real time electricity markets depends at least partially on the aggregator's ability to control loads and in particular to reduce loads when real time prices are high. Generally power the average price over power over the course of a year is about 20 to 25% less than the flat rate prices of power offered by utilities and energy service providers, but real time prices can be higher than utility prices a few hundred hours of the year.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 shows a block diagram of a prior art electric power delivery system.

FIG. 2 shows a block diagram of an energy management system in accordance with the present invention.

FIG. 3 shows a block diagram of an energy management system in accordance with the present invention.

FIG. 4 shows a block diagram of an energy management system in accordance with the present invention.

FIG. 5 shows a block diagram of an energy management system in accordance with the present invention.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

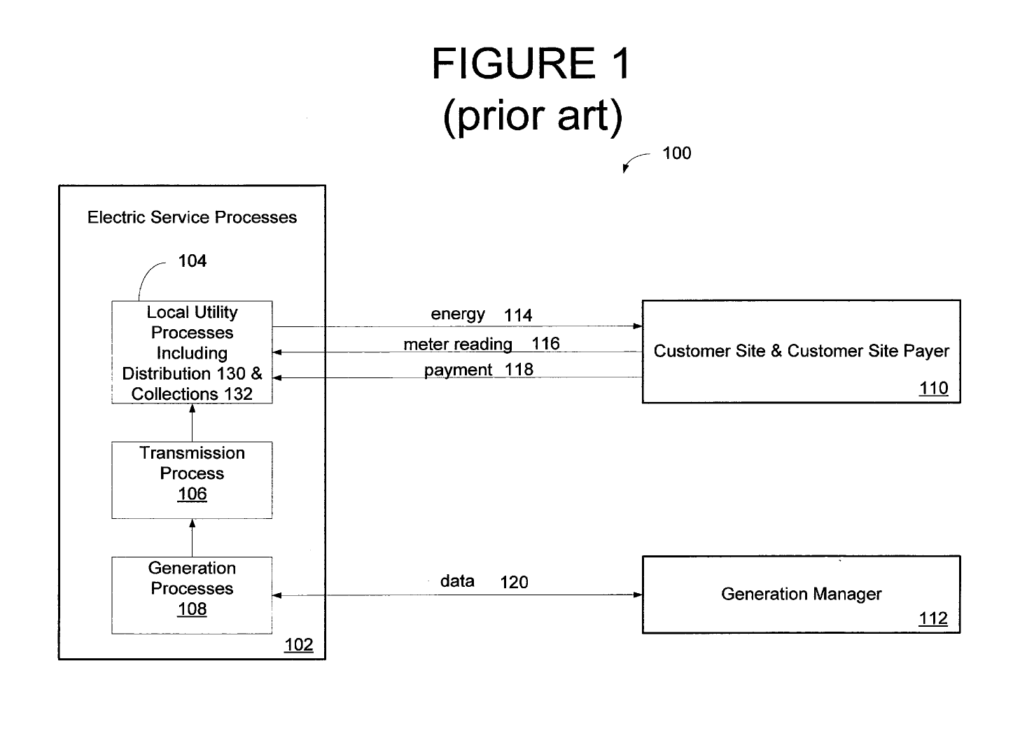

FIG. 1 shows a block diagram of a prior art electric power delivery system 100. Here, electric service processes 102 serve customer sites 110 while generation management processes 112 balance generation 108 with demand.

In various embodiments, generation management 112 is carried out by an electric service company such as an electric utility company and in various embodiments generation management is carried out by an external entity such as an Independent System Operator (“ISO”) or Regional Transmission Authority (“RTA”). Where an external generation management entity is involved, some embodiments provide a plurality of integrated electric service entities (“utilities”) or electric generating entities within a generation manager's control.

Electric service processes 102 include local utility processes 104, transmission process 106, and generation process 108. Local utility processes encompass electric distribution 130 and collection processes 132 such as customer invoicing and payment processes.

Distribution processes interface with customer sites for supplying energy to customer sites. These distribution processes utilize a physical interface including distribution equipment such as distribution power lines 114. Collection processes interface with customer sites and/or customer site payors to receive compensation for services provided.

Collection processes utilize meter reading (physically or remotely read) 116 to determine consumption energy charges. Collection processes also include preparing invoices and receiving payments (information and funds transfers) 118.

Meter reading 116 includes remote reading of meters and manual reading of meters where necessary. Collection processes 132 interface with customer sites 110 when invoices are provided to and payments are received from customer sites and/or customer site payors (information and funds transfer interfaces) 118.

Local utility processes 104 are enabled by transmission processes 106 which are in turn enabled by generation processes 108. The transmission process is coupled to local utility processes via a transmission/local utility physical interface 134. This physical interface typically includes high voltage electric power transmission lines that interconnect with lower voltage distribution equipment via substations including step-down transformer(s).

Generation processes 108 supply power to enable the transmission processes 106. The generation processes are coupled to the transmission processes via a generation/transmission physical interface 136. This physical interface typically includes medium voltage electric power lines interconnecting with high voltage electric power transmission lines via step-up transformer(s).

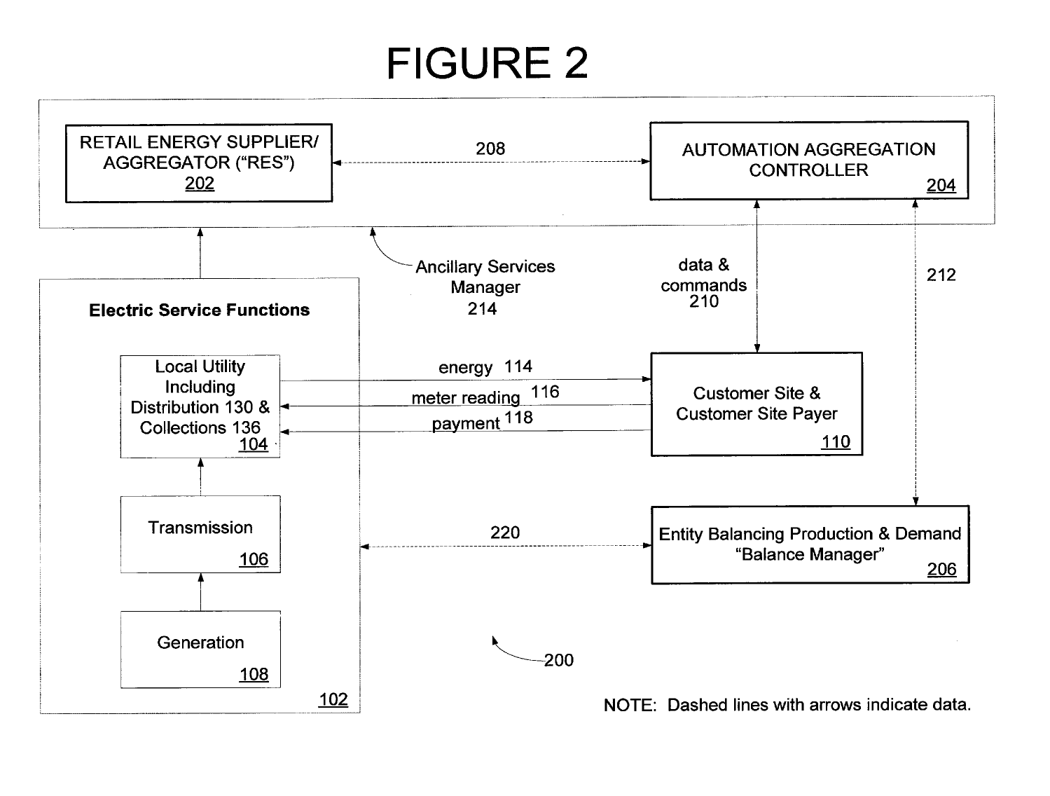

FIG. 2 shows an energy management system in accordance with the present invention 200. The energy management system includes an ancillary services manager 214, electric utility functions 102, a customer site and customer site payor 110 and an entity balancing production and demand (“balance manager”) 206.

Ancillary services of the ancillary services manager 214 include retail energy supplier/aggregation (“RES”) services 202 and automation aggregation controller (“AAC”) services 204. A data transfer medium enables the RES and the AAC to exchange data.

An entity balancing production & demand (“balance manager”) 206 exchanges data 220 with the electric utility functions 102 and with an ancillary services manager 214. The ancillary services manager also exchanges data and commands with the customer site 210 and in some embodiments with a customer site payor 110 (as shown).

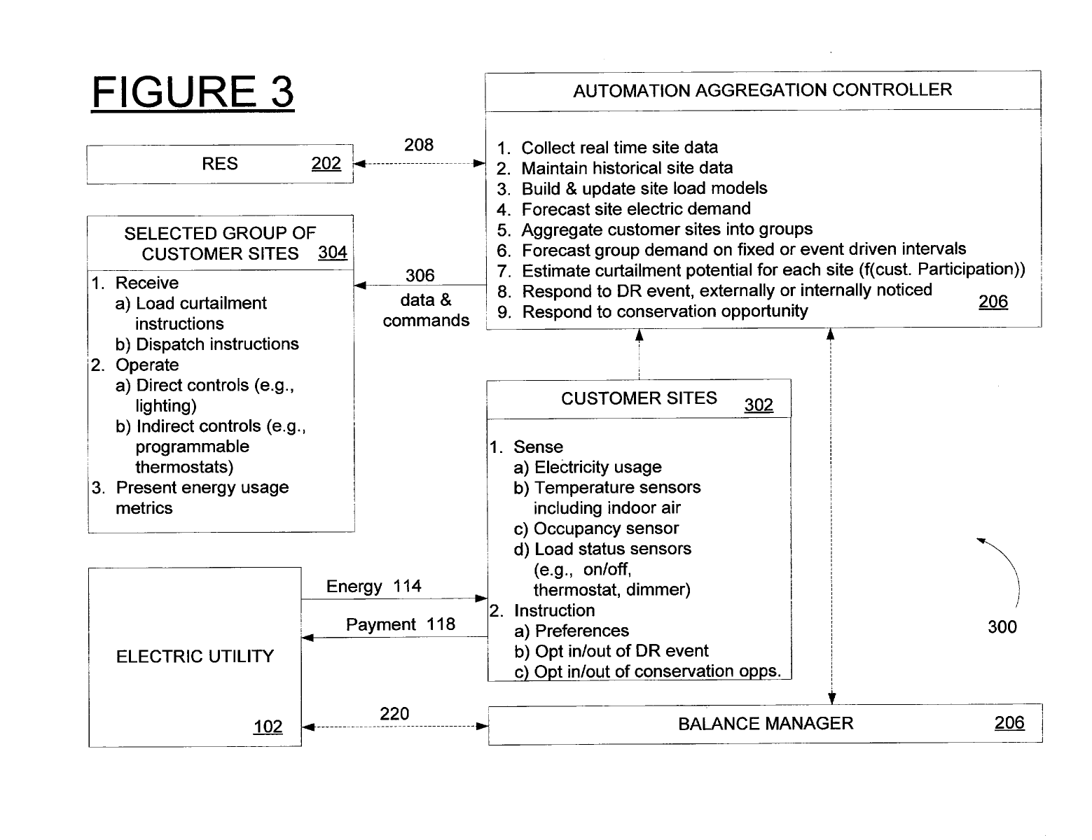

FIG. 3 shows an embodiment of the energy management system of the present invention 300. The system includes a RES 202, an AAC 204, customer sites 304, a selected group of customer sites 302, an electric utility entity performing one or more electric utility functions 102, and a balance manager 206.

The RES 202 and the AAC 204 exchange data 208. Customer sites 302 exchange data and commands 308 with the AAC 204, receive energy 114 from the electric utility function 102, and make payments 118 to the electric utility function. The balance manager 206 exchanges data 220, 212 with each of the electric utility function and the AAC 102, 204. The electric utility function also exchanges data 220 with the balance manager 206. In various embodiments, there is a selected group of customer sites 304 that exchanges data and commands 306 with the AAC.

As discussed above, the AAC 204 exchanges data and commends with the RES 202, customer sites, a selected group of customer sites 304, and with the balance manager 206.

Main functions of the AAC include data collection, data analysis, and responding to energy management choices.

AAC data collection includes collecting real time customer site data and maintaining that historical site data or a subset of it. From the customer site data, the AAC builds and then updates site electric load models. These models are used to forecast demand.

Knowledge of site electricity demand is used in various embodiments to gather customer sites into groups that provide an aggregate electricity demand that is favorable when electricity pricing is considered. For example, customer sites can be grouped to levelize the load such that load variation with respect to average load is reduced. The electricity demand or load profile for each group of sites is forecast by summing the individual site forecasts, a calculation performed as needed, for example on fixed or event driven intervals or times.

Estimates of the curtailment potential for each site 302 and for each group of sites 304 are made by the AAC 204. Curtailment potential refers to discretionary electric loads at one or more customer sites that can be remotely managed to reduce the site(s) electricity demand. In some embodiments, these estimates take into account a customer's choice to participate in or forgo participation in a load curtailment program. The AAC 204 estimates curtailment potential for each site 302 and for each group of sites 304.

With forecasted electric load profiles for customer sites 302 and for groups of customer sites 304, the AAC can anticipate individual and aggregate loads. Load profile anticipation provides an opportunity to manage particular loads and aggregate loads such that these loads come within favorable terms of electric services contracts such as electric supply contracts.

Participation in demand response events is enabled by possession of curtailment potential estimates for each site 302 and each group of sites 304. The AAC 204 is capable of participating in demand response events whether they be externally noticed, such as by the balance manager 206 or the electric utility 102, or internally noticed, such as by the AAC or the RES 202. In a similar fashion, the AAC can respond to electricity conservation opportunities. And, where there is a take or pay electricity supply contract, the AAC can make excess power available for sale or end energy saving programs such as load curtailment.

As discussed above, the customer sites 302 exchange data with the AAC 204. Main functions of the customer sites include sensing site data and receiving site instructions.

Sensing site data includes several measurements. Electricity usage is measured and in various embodiments the status of selected loads (e.g., on/off) is monitored. In addition, occupancy is sensed and temperature(s) including indoor air temperature are measured.

Customer site occupants and/or customer site payors provide instructions relating to the customer sites. Instructions pertaining to preferences are given. In addition, demand response and conservation opportunities can be opted into or out of.

As discussed above, selected sites are grouped 304 for purposes such as load leveling through aggregation. The AAC exchanges data and commands 306 with the customer sites within the group. In various embodiments, all of the sites within the group receive common commands. And, in some embodiments particular sites within the group receive individualized commands.

Load curtailment instructions are typically particularized as are commands dispatching electricity sources such as motor-generator sets. Instructions received at the sites cause operation of direct controls such as lighting controls. Instructions received at the sites also operate indirect controls such as programmable thermostats. Direct Instructions control devices such as site lighting.

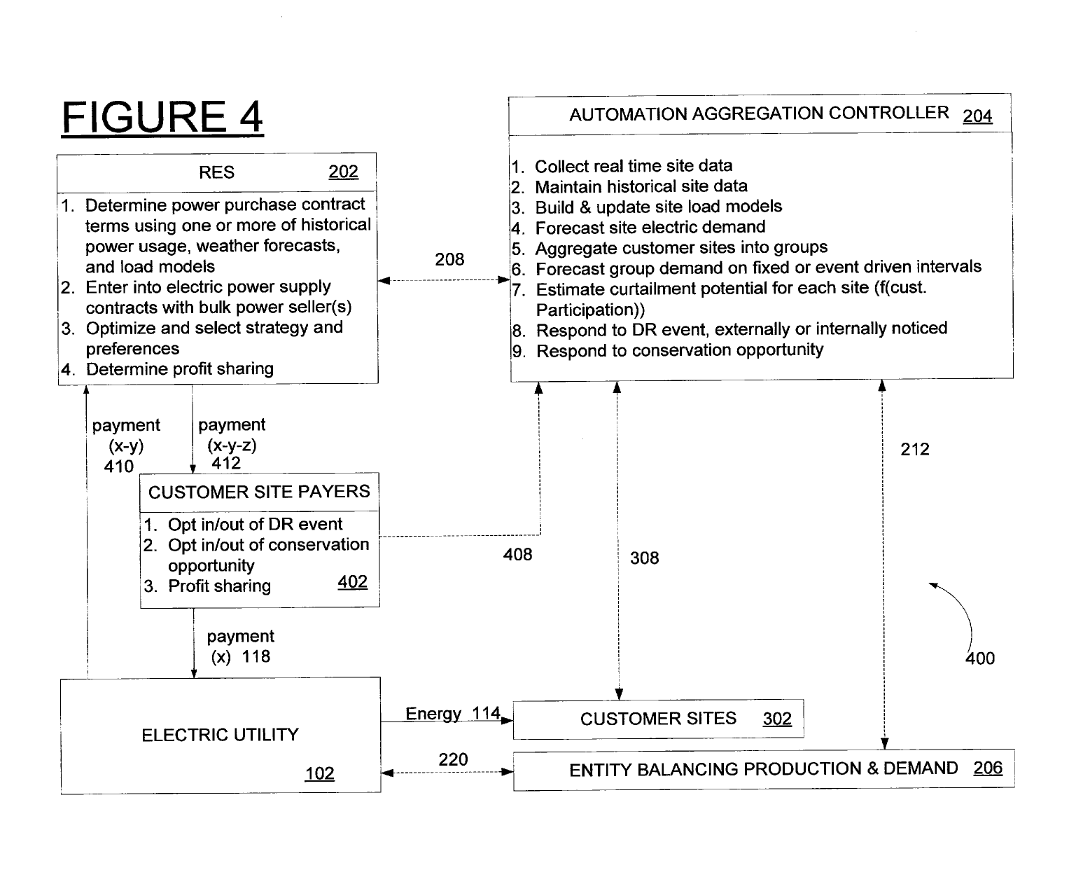

FIG. 4 shows an embodiment of the energy management system of the present invention 400. The system includes a RES 202, an AAC 204, customer sitepayors 402, an electric utility or entity performing one or more electric utility functions 102, customer sites 302, and a balance manager 206.

As shown, the RES 202 exchanges data with the AAC 204. AAC data including one or more of historical power usage, weather forecasts, and load models provide the RES with a basis for determining power purchase contract parameters including one or more of average load, time of day load, peak loads, and duration of peak loads. Taking these parameters into account, the RES enters into electric power supply contracts with power seller(s) such as bulk power seller(s).

Profit sharing is also determined by the RES. In an embodiment, the electric utility 102 collects 118 payments (x) from customer site payors 402. The utility retains a portion of the payment (y) and sends 410 the balance (x-y) to the RES 202. The RES determines its share (z) and sends 412 the balance (x-y-z) to the customer site payor. In other embodiments, the rebate is deducted from an electric services invoice the utility sends the customer site payor avoiding an ex post facto rebate. In various embodiments, customer site payors opt in and/or out of one or more of demand response events, energy conservation opportunities, and profit sharing.

In various embodiments, the RES 202 optimizes electric supply and selects strategy and preferences. For example, while holding long term supply contracts, the RES may contract to sell back take or pay blocks of power on certain days as a part of daily tactics and strategy. In an embodiment, such a transaction takes place when the RES holds surplus power. Support for various of these RES functions includes the availability of forecasts such as AAC forecasts taking into account load that must be served with real-time purchases and the cost of such purchases.

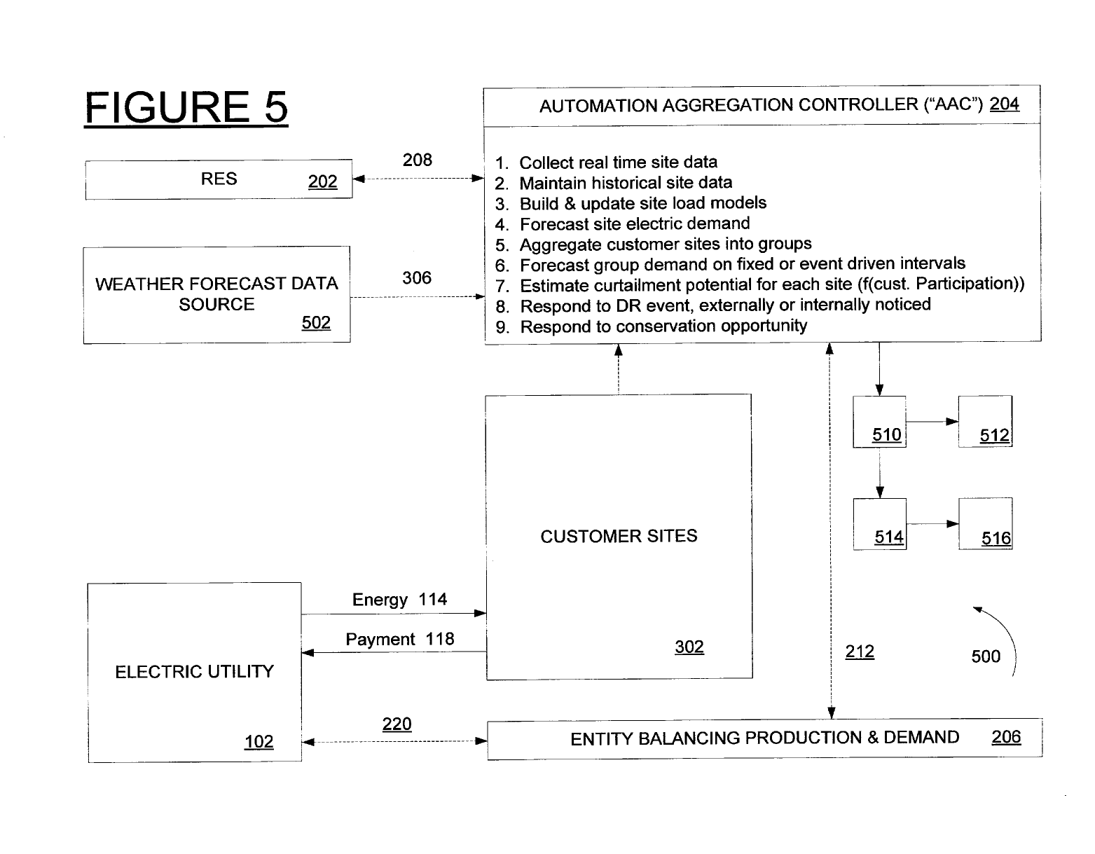

FIG. 5 shows an embodiment of the energy management system of the present invention 500. The system includes a RES 202, an AAC 204, customer sites 302, an electric utility 102, a weather forecast data source 502, and a balance manager 206.

In addition, some embodiments include a data server 510 supplying data directly to customers 512 and/or supplying data to customers 516 via an application such as an IPHONE® application, another mobile device application, or via any suitable internet connected device.

An addendum to this specification provides additional disclosure of the present invention. In particular, text and figures describe additional embodiments of the present invention together with descriptions of algorithms incorporated in various embodiments of the invention. The Addendum forms a part of this specification and is included herewith.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. An energy management system comprising:
an electric utility business including an electric distribution utility;
supply lines of the electric distribution utility interconnecting with loads at customer sites;
an ancillary services manager including a retail energy supplier (“RES”) and an automation aggregation controller (“AAC”);
a balance manager for balancing electricity production and demand;
the ancillary services manager for receiving data from the electric utility business and bidirectionally exchanging data with the customer sites;
the balance manager for bidirectionally exchanging data with each of the electric utility business and the ancillary services manager; and,
wherein the ancillary services manager aggregates customers into groups for levelizing group electric power demand and the retail energy supplier determines power purchase terms suited to each group.

2. The energy management system of claim 1 further comprising:
an electricity usage sensor at each customer site;
an indoor air temperature sensor at each customer site; and,
an occupancy sensor at each site; and, one or more load status sensors at each site.

3. The energy management system of claim 2 wherein the AAC:
collects real time site data; maintains historical site data;
builds and updates site load models;
forecasts site electric demand;
aggregates customer sites into groups;
forecasts group demand on fixed or event driven intervals; estimates curtailment potential for each site;
responds to demand response events externally noticed;
responds to demand response events internally noticed; and,
responds to electric power conservation opportunities.

4. The energy management system of claim 3 wherein the AAC:
sends load curtailment instructions to selected sites within a group;
sends dispatch instructions to selected sites within a group;
operates direct controls at selected sites within a group;
operates indirect controls at selected sites within a group; and,
provides energy usage metrics available to site occupants or site payees for each site within the group.

5. The energy management system of claim 3 wherein the RES:
determines power purchase contract terms using one or more of historical power usage, weather forecasts, and load models;
enters into electric power purchase contracts with bulk one or more bulk power sellers;
optimizes and selects strategy and preferences and sends them to the AAC; and,
determines profit sharing with customer site payers.

6. An energy management method comprising the steps of:
installing sensors and controls at a plurality of customer sites;
collecting customer site electric power use data at the customer sites;
forecasting electric power demand for each customer site based on time of day, day of year, weather forecast data, and historical electric power use data;
gathering customers sites into multiple groups such that at least for one group, the difference between group peak load and group average load is less than the difference between the peak load and average load of all the groups combined;
obtaining one or more electric power contracts to supply electric power to the groups;
shifting selected customer site loads temporally away from forecasted peak loads by pre-cooling when needed to come within the electric power demand allowed by a particular electric power contract; and,
curtailing one or more loads of one or more selected customer sites when needed to come within the electric power demand allowed by a particular electric power contract.

7. An energy management method comprising the steps of:
installing sensors and controls at a plurality of customer sites;
collecting customer site electric power use data at the customer sites;
forecasting electric power demand for each customer site based on time of day, day of year, weather forecast data, and historical electric power use data;
gathering customers sites into multiple groups such that at least for one group, the difference between group peak load and group average load is less than the difference between the peak load and average load of all the groups combined;
receiving electric power rate data from a rate setting entity;
shifting selected customer site loads temporally away from forecasted peak loads by pre-cooling when needed to reduce electric power demand in accordance with a demand response agreement; and,
curtailing one or more loads of one or more selected customer sites when needed to reduce electric power demand in accordance with a demand response agreement.

8. An energy management system comprising: sensors and controls installed at a plurality of customer sites;
an electric utility business including an electric distribution utility;
supply lines of the electric distribution utility interconnected with loads at the customer sites;
an ancillary services manager including a retail energy supplier (“RES”) and an automation aggregation controller (“AAC”);
a balance manager for balancing electricity production and demand;
the ancillary services manager operable to receive data from the electric utility business and bidirectionally exchange data with the customer sites;
the retail energy supplier operable to exchange data with the automation aggregation controller;
the balance manager bidirectionally operable to exchange data with each of the electric utility business and the ancillary services manager; and,
wherein the ancillary services manager aggregates customers into groups for levelizing group electric power demand and the retail energy supplier determines power purchase terms that match the electric power consumption characteristics of one or more groups.

9. The energy management system of claim 8 further comprising:
an electricity usage sensor at each customer site;
an indoor air temperature sensor at each customer site; an occupancy sensor at each site;
one or more load status sensors at each site; and,
wherein the automation aggregation controller is configured to receive electricity usage data, indoor air temperature data, and occupancy data from the customer sites, actual and forecast weather data for the customer sites from a weather data service, strategy and preferences (instructions) from a retail electricity supplier, electricity price data and demand response event data from an entity managing electric generation, and price data and demand response event data from the balance manager.

10. The energy management system of claim 9 further comprising:
customer site communications facilities that enable communications between each site and the ancillary services manager; and,
wherein each customer site is configured to receive direct control instructions including one or more of electric air conditioning and electric hot water heating curtailment instructions from the AAC, indirect control instructions including one or more of set points for electric air conditioning thermostats and electric hot water heater thermostats from the AAC, and electricity supply from the electric power utility.

11. The energy management system of claim 10 further comprising:
ancillary services communications facilities that enable the ancillary services manager to communicate with the balance manager, the automation aggregation controller, and the electric utility business; and,
wherein the retail energy supplier is configured to receive electricity price data and demand response event data from the balance manager, historical and real time electricity use data for each of the customer sites from the automation aggregation controller, payment information from the electric utility business, and electricity contract information from the electric utility business.

12. The energy management system of claim 11 further comprising:
the ancillary services manager operable to reduce at least one of electricity consumption and electricity rates for a plurality of the customer sites; and,
wherein the site payers receive electricity service billing from the electric utility business, and a portion of the benefits from reduced electricity consumption and reduced electricity rates.

13. The energy management system of claim 12 further comprising:
electric power supply contracts; and,
wherein the electric utility business enters into electric power supply contracts from the retail energy supplier, receives energy supply from the entity managing electric generation, and receives electricity supply payments from customer site payers.

14. The energy management system of claim 13 further comprising:
historical electric power usage data collected by the ancillary services manager; and,
wherein the retail energy supplier utilizes historical electric power usage data to determine appropriate electric power supply contract terms, aggregates customers into one or more groups to livelier the electricity demand profile of at least one group, enters into electric power supply contracts with utility companies, and curtails customer site loads in response to demand response events.

15. An energy management method comprising the steps of:
installing sensors and controls at a plurality of customer sites;
an automation aggregation controller (AAC) receiving electricity usage data, indoor air temperature data, and occupancy data from the customer sites, actual and forecast weather data for the customer sites from a weather data service, strategy and preferences (instructions) from a retail electricity supplier (RES), electricity price data and demand response event data from an entity managing electric generation, and price data and demand response event data from an electric power utility;
customer sites receiving direct control instructions including one or more of electric air conditioning and electric hot water heating curtailment instructions from the AAC, indirect control instructions including one or more of set points for electric air conditioning thermostats and electric hot water heater thermostats from the AAC, and electricity supply from the electric power utility;
the retail energy supplier receiving electricity price data and demand response event data from an entity managing electric generation, historical and real time electricity use data for each of the customer sites from the AAC, payment information from the electric power utility, and electricity contract information from the electric power utility; customer site payers receiving profit sharing from the retail energy supplier, billing from the electric power utility, and rebates from the electric power utility;
an electric power utility receiving electricity contracts from the retail energy supplier, energy supply from the entity managing electric generation, installation services from customer site payers, electricity supply payments from customer site payers, and responding to the received data, instructions, and signals by controlling loads at the customer sites; and,
the retail energy supplier utilizing historical electric power usage data to determine appropriate electric power supply contract terms, aggregating customers into one or more groups to levelize the electricity demand profile of at least one group, entering into electric power supply contracts with utility companies, and curtailing customer site loads in response to demand response events.

16. The energy management method of claim 15 further comprising the steps of:
the retail energy supplier entering into sufficient fixed price electricity contracts to serve at least the aggregate minimum load of the customer sites; and,
for a group of customer sites and a particular time period, the retail energy supplier
forecasting a future load profile for the group,
curtailing loads at group customer sites during at least a selected time interval within the time period, the selected time interval having the highest electricity cost during the time period,
purchasing sufficient electricity in a day ahead electricity market to satisfy the forecasted curtailed requirement to the extent it exceeds the contracted base load electricity supply, and
purchasing sufficient electricity in a real time electricity market to satisfy the actual electricity requirement to the extent it exceeds the contracted base load electricity supply plus the electricity purchased in the day ahead market.

17. The energy management system of claim 16 further comprising the steps of:
the AAC including a database;
the database bidirectionally exchanging information with users via a user interface server communicating with user handheld devices, optimization and conservation algorithms, a device server communicating with devices and sensors at each customer site via a device gateway, and internet and web services;
the user interface server bidirectionally exchanging information with the optimization and conservation algorithms;
the optimization and conservation algorithms bidirectionally exchanging information with the device server and the internet web services; and,
with the exception of the user handheld device communications and the device server communications via the device gateway, each of the above communications takes place in the cloud.

18. An energy management system comprising:
a retail energy supplier and an automaton aggregation controller;
a plurality of electric power sensors and controls installed at a plurality of customer sites;
the automation aggregation controller bidirectionally exchanging data with the customer sites; the automation aggregation controller utilizing customer site data to build an energy usage database;
the automation aggregation controller utilizing customer site energy usage data to model customer site energy demands as a function of environmental variables including time of day and outdoor temperature;
the automation aggregation controller utilizing models of customer site energy demands to predict future unmanaged demand and future managed demand; and,
the retail energy supplier utilizing the automation aggregation controller managed demand predictions and customer groupings that tend to levelize group electric loads to obtain electric power supply contracts that save costs as compared to contracts for supplying unmanaged demand.

19. An energy management system comprising:
an electric utility group including one or more electric utility companies;
an electric system operator including one of an independent system operator (“ISO”) and a regional transmission operator (“RTO”);
a group of energy end users including one or more of building owners, site occupants, tenants occupying tenant owned space, and owners occupying owner owned space;
an aggregator operable to identify one or more subgroups within the end user group, each subgroup having electric energy usage characteristics that are less costly to serve than the electric energy usage characteristics of the group of energy end users; and,
a retail energy supplier (“RES”) utilizing information from the aggregator to coordinate electric supply and demand activities of the electric utility group, the electric system operator, and plural users from the group of end users.

20. The energy management system of claim 19 further comprising:
a load re-shaper;
the load re-shaper matching selected commercial customers and selected residential customers chosen from the group of energy end users; and,
the load re-shaper operable to reduce electric demand variation for a subgroup of the selected commercial and residential customers as compared with the electric demand variation of the group of energy end users.

21. The energy management system of claim 20 further comprising:
a collection of internet enabled services incorporated in a cloud service and communicating with one or both of sites and end users;
the cloud service exchanging information with one or more end user personal applications via web enabled end user devices; and,
the cloud service including a database exchanging information with each of a user interface server, an optimization and conservation server including an aggregator, and a device server for communicating with end user sites.

22. The energy management system of claim 21 further comprising:
a plurality of end user sites, each site incorporating a Local Energy Management System (“LEMS”);
the LEMS including passive and active controls;
LEMS passive controls including a motion sensor, remotely activated lighting switch, remotely activated hot water heater switch, remotely activated HVAC switch, and plural remotely activated appliance switches;
LEMS active controls include a remotely programmable thermostat;
a multi-button selector for selecting from plural energy management modes operating LEMS in a predetermined manner, the selections including vacation mode; and,
the LEMS including a communications gateway exchanging information with the device server.

23. The energy management system of claim 22 further comprising:
LEMS occupancy states including in, out, and vacation; and,
a particular occupancy state being determined by one or more of the motion detector, a relationship between an indicated time and a predetermined time interval, and one or more other occupancy states.

24. The energy management system of claim 22 further comprising:
a LEMS test for vacation mode that utilizes energy consumed during a trailing period of time, utilizes a rolling average of actual energy consumption profiles, and utilizes a percentage reduction from an average hourly energy use profile.

25. The energy management system of claim 22 further comprising:
a characterization of pool pump power consumption as a function of a comparison of a power consumed in a time period with the pump turned off with a power consumed in an equal time period with the pump turned on.

26. The energy management system of claim 22 further comprising:
a characterization of lighting power consumption as a function of a comparison of a power consumed in a time period with the lighting turned off with a power consumed in an equal time period with the lighting turned on.

27. The energy management system of claim 22 further comprising:
a characterization of electric water heater power consumption as a function of a comparison of a power consumed in a time period with the electric water heater turned off with a power consumed in an equal time period with the electric water heater turned on.

28. The energy management system of claim 22 further comprising:
a characterization of refrigerator power consumption as a function of a comparison of a power consumed in a time period with the refrigerator turned off with a power consumed in an equal time period with the refrigerator turned on.

29. The energy management system of claim 22 further comprising:
a space conditioning system including a vapor compression cycle machine and one of a resistance heating unit and a gas heating unit;
a characterization of a vapor compression cycle machine power consumption as a function of a comparison of a power consumed in a time period with the vapor compression cycle machine turned off with a power consumed in an equal time period with the vapor compression cycle machine turned on; and,
a characterization of a heating unit power consumption as a function of a comparison of a power consumed in a time period with the heating unit turned off with a power consumed in an equal time period with the heating unit turned on.

30. The energy management system of claim 22 further comprising:
a space conditioning system including a variable speed vapor compression cycle machine; and,
for a plurality of vapor compression cycle machine speeds, a characterization of a respective machine power consumption as a function of a comparison of a power consumed in a time period with the machine turned off with a power consumed in an equal time period with the machine turned on.

31. The energy management system of claim 22 further comprising:
a summer or winter indication and a time of day indication;
a lighting control operative to turn lights off during the summer during a first predefined time period; and,
the lighting control operative to turn lights off during the summer during a second predefined time period.

32. The energy management system of claim 22 further comprising:
summer, working day, and time of day indications; and,
an air conditioner control operative to turn an air conditioning machine on when summer is indicated and a working day is indicated, and time of day reaches a predetermined time of day.

33. The energy management system of claim 22 further comprising:
a control for shedding electric power loads of sites of a subgroup;
when the subgroup load exceeds a contracted load limit, the shedding control operative to identify sites that have not opted out of a demand management program authorizing automated demand management actions at the site, for identified sites, the shedding control system operative to shed pool pump loads, cycle air conditioning equipment to reduce cumulative air conditioning load, and, shed selected lighting loads; and,
the shedding control system operative to cease load shedding when the contracted load limit exceeds the subgroup load by a predetermined margin.

34. The energy management system of claim 33 further comprising:
a cyclic mode of the shedding control that maintains subgroup load within the contracted load limit for a second time period immediately following a first time period when subgroup load exceeded the contracted load limit; and,
a third period immediately following the second time period when subgroup load exceeds the contracted load limit.

35. The energy management system of claim 34 further comprising:
an opportunistic demand control mode operative to identify an electric sales opportunity as a function of indications of a price threshold and the passage of a predetermined period of time; and,
the opportunistic demand control mode operative to make electricity the subgroup would have used, but for managing its demand through at least one of load shedding and local generation, available for sale.

36. The energy management system of claim 35 further comprising:
a power reduction estimator comparing subgroup power demand and a power threshold setting to generate a load reduction target where demand exceeds the setting;
a prioritized load list identifying the next available load to be shed; the estimator operative to select one or more loads from the prioritized load list equal the load reduction target plus a load margin; and,
the demand control mode operative to shed loads identified by the estimator until the subgroup power demand falls below the power threshold setting.

37. The energy management system of claim 36 wherein:
an electric sales opportunity is identified; and,
subgroup electric demand is reduced by
consulting a do not stop list,
turning off a pool pump that is not on the do not stop list,
cycling a vapor compression space conditioning machine to run at intervals no longer than 7.5 minutes, and
turning off lighting that is not on the do not stop list.

38. The energy management system of claim 36 wherein:
an electricity pricing event is determined to be expected or unexpected based on indications from the pricing estimator and a real time pricing data provider, unexpected pricing events being found where real time pricing exceeds the price threshold for more than five minutes.

39. The energy management system of claim 38 wherein:
a determination that an unexpected price event has occurred results in electric demand being reduced by
consulting a do not stop list,
turning off a pool pump that is not on the do not stop list,
cycling a vapor compression space conditioning machine to run at intervals no longer than 7.5 minutes, and
turning off lighting that is not on the do not stop list.
